(19) United States
(12) Patent Application Publication
(10) Pub. No.: US 2008/0158121 A1
(43) Pub. Date: Jul. 3, 2008

(54) System and method for gamma regulating of liquid crystal display

(75) Inventors: Chang-Jun Liu, Shenzhen (CN); Gang-Qiang Zheng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/006,000

(22) Filed: Dec. 29, 2007

(30) Foreign Application Priority Data
Dec. 29, 2006 (TW) 95149718

(51) Int. Cl. G09G 3/36

(52) U.S. Cl. 345/89

(57) ABSTRACT

An exemplary gamma regulating system (20) for an LCD has a test-needed LCD (26), a light sensor (21), and a MCU (24). The LCD displays each gray scale image according to internal presetting standard gamma curve. The light sensor measures a luminance value of the gray scale image displayed by the test-needed LCD, and converts the luminance value to a voltage signal. The MCU compares the voltage signals representing the measured luminance values with the parameter data corresponding to the standard gamma curve, and regulates a gray voltage according the comparing result.

### FIELD OF THE INVENTION

The present invention relates to a system and method for gamma regulating of a liquid crystal display.

### BACKGROUND

LCDs are commonly used as display devices for compact electronic apparatuses, because they not only provide good quality images with little power but also are very thin. In general, an LCD includes a liquid crystal panel and a backlight module for illuminating the liquid crystal panel.

The LCD panel needs to be driven by gamma voltages in order to display images. The gamma voltages are provided by an external apparatus. Each gray scale of the images displayed by the LCD panel corresponds to a gamma voltage signal.

The LCD usually further includes a gamma circuit having a gamma regulating table for regulating the gamma voltage signals according to a predetermined gamma parameter γ. The gamma parameter γ can be, for example, 2.2. The regulating process is generally based on a formula Y=A*X^{γ} (where A is a constant, X represents a gamma voltage signal, and Y represents a corresponding gray scale). The gamma voltage signals and the corresponding gray scales are content of the gamma regulating table. However, because different LCDs inevitably have inherent differences, the gamma parameter preset may not adapt to every individual LCD. That is, for different LCDs, the actual gray scales are not the best gray scales to display images. The gamma regulating table is therefore inappropriate.

FIG. 3, is a flowchart summarizing a conventional method for regulating a presetting gamma curve or a presetting gamma table for a liquid crystal display. The method includes steps as follows:

step S1: providing a gray scale image to a test-needed LCD;

step S2: measuring an actual luminance value of the gray scale image;

step S3: recording the luminance value, the corresponding gray scale and the corresponding gray voltage;

step S4: repeating the above-described steps, and recording all luminance values, and gray scale voltages corresponding to all gray scales, and generating a gamma table or a gamma curve; and

step S5: comparing the generated gamma table or gamma curve with a standard gamma table or a standard gamma curve to determine whether the gray voltages need to be regulated.

However, in the conventional method, the operator need to compare the luminance values corresponding to all the gray scales with the standard gamma table or the standard gamma curve one by one, and regulate the gray voltages one by one if the difference between the luminance value and the standard luminance value excesses the presetting error band. Thus, the whole gamma regulating need a great deal of manpower and working hours, which improves the manufacturing cost.

What is needed, therefore, is a system and method for gamma regulating of a liquid crystal display that can over come the above-described deficiencies.

### SUMMARY

An exemplary gamma regulating system for an LCD has a test-needed LCD, a light sensor, and a MCU. The LCD displays each gray scale image according to internal presetting standard gamma curve. The light sensor measures an actual luminance value of the gray scale image displayed by the test-needed LCD, and converts the luminance value to a voltage signal. The MCU compares the voltage signal representing the measured luminance value with the parameter data corresponding to the standard gamma curve, and regulates a gray voltage according the comparing result.

An exemplary gamma regulating method for an LCD, includes providing a test-needed LCD and operating the LCD to display each gray scale image according to internal presetting standard gamma curve; measuring an actual display luminance through a light sensor and converting the display luminance to a voltage signal; comparing the voltage signals representing the actual luminance values with the parameter data corresponding to the standard gamma curve, and regulating a gray voltage according the comparing result by a micro control unit (MCU).

Other novel features and advantages will become apparent from the following detailed description of preferred and exemplary embodiments when taken in conjunction with the accompanying drawings.

### BRIEF DESCRIPTION OF THE DRAWINGS

FIG. 1 is a block diagram of a circuit configuration of a gamma regulating system for a liquid crystal display device according to a first embodiment of the present invention.

FIG. 2 is flowchart summarizing a method for regulating a gamma table or a gamma curve for a liquid crystal display used in the gamma regulating system of FIG. 1. and

FIG. 3 is flowchart summarizing a conventional method for regulating a gamma table or a gamma curve for a liquid crystal display.

### DETAILED DESCRIPTION OF PREFERRED EMBODIMENTS

Reference will now be made to the drawings to describe preferred and exemplary embodiments in detail.

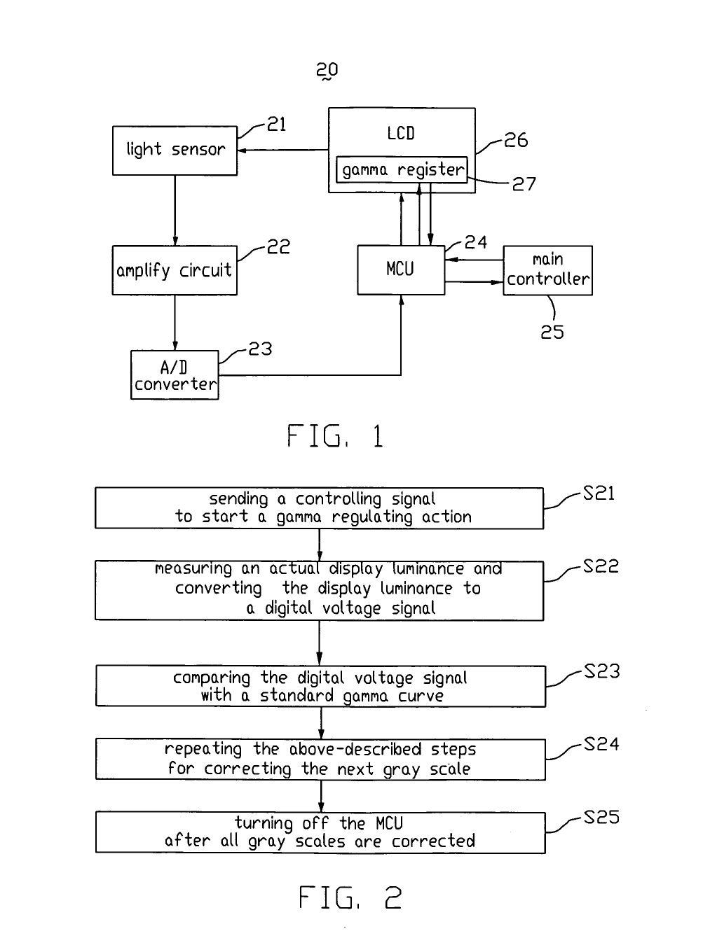

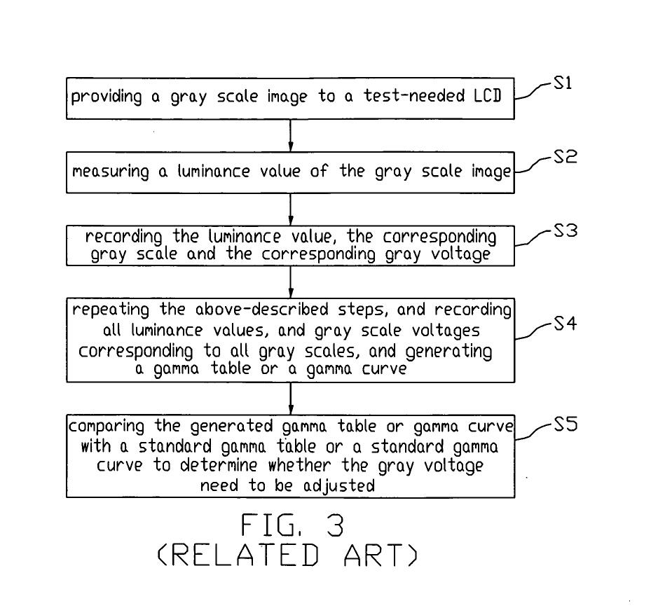

FIG. 1 shows a block diagram of a circuit configuration of a gamma regulating system for a liquid crystal display device according to a first embodiment of the present invention. The gamma regulating system 20 has a light sensor 21, an amplify circuit 22, an analog/digital (A/D) converter 23, a micro control unit (MCU) 24, a main controller 25 and a test-needed liquid crystal display (LCD) 26. The main controller 25 sends a controlling signal to the MCU 24 to turn on the MCU 24 for starting a gamma regulating action. The MCU 24 creates a plurality of data signals respectively representing each gray scale image, and sends the plurality of data signals to the test-needed LCD 26 for displaying the gray scale image. The light sensor 21 measures the actual luminance value of the current gray scale image displayed by the test-needed LCD 26, and converts the luminance value to an analog voltage signal. After the analog voltage signal is transmitted to the amplify circuit 22, the analog voltage signal is scaled up and is sent to the A/D converter 23. The A/D converter 23 converts the analog voltage signal to a digital voltage signal representing the actual luminance value, and sends the digital voltage signal to the MCU 24.

The LCD 26 has a gamma register 27 for storing parameter data and corresponding gray voltage values. The parameter data buildup a standard gamma curve or a standard gamma table. The parameter data include corresponding gray scale values and corresponding standard luminance values. The LCD 26 displays the gray scale images according to the parameter data stored in the gamma register 27. The MCU 24 reads the parameter data of a presetting standard gamma curve, and compares the standard luminance values with the digital voltage signals representing the actual luminance values measured by the light sensor 21. In addition, the MCU 24 further regulates the gray voltage according the comparing result until the digital voltage signal representing the measured luminance value is in a range of allowable error band for the presetting standard luminance values of the standard gamma curve. Finally, the regulated gray voltage is rewritten into the gamma register 27 to finish the gamma regulating.

FIG. 2 is flowchart summarizing a method for regulating a gamma table or a gamma curve for a liquid crystal display used in the gamma regulating system of FIG. 1. The gamma regulating method has following steps:

step S21: sending a controlling signal to start gamma regulating action;

step S22: measuring a display luminance and converting the display luminance to a digital voltage signal;

step S23: comparing the digital voltage signal with a standard gamma curve;

step S24: repeating the above-described steps for regulating the next gray scale; and

step S25: turning off the MCU after all gray scales are regulated.

In step S21, the main controller 25 sends a controlling signal to the MCU 24 to start gamma regulating action. The MCU 24 creates a plurality of data signals respectively representing one gray scale image, and sends the plurality of data signals to the test-needed LCD 26. The test-needed LCD 26 calls the parameter data corresponding to the presetting standard gamma curve and corresponding gray voltages to display the gray scale image.

In step S22, the light sensor 21 measures the actual luminance value of the gray scale image displayed by the test-needed LCD 26, and converts the luminance value to an analog voltage signal. Because the MCU 24 can not recognize the analog signals, the analog voltage signal need to be scaled up by the amplify circuit 22 and need to be converted to the digital voltage signal representing the actual luminance value by the A/D converter 23.

In step S23, the MCU 24 receives the digital voltage signal, and reads the standard parameter data of the presetting standard curve, i.e. a standard luminance value corresponding to the currently gray scale. After that, the MCU 24 compares the standard luminance value to the digital voltage signal representing the measured luminance value. If the digital voltage signal is in the range of allowable error band of the presetting standard luminance values, the gray scale image display of the LCD 26 is normally for the current gray scale, and no regulating action need to be performed. The gamma regulating system 20 goes back to step S21 for next gray scale regulating. Contrarily, if the digital voltage signal excesses the range of allowable error band of the presetting standard luminance values, the gray scale image display of the LCD 26 is abnormally for the current gray scale, and a regulating action need to be performed. The MCU 24 calls a regulating order to correct the corresponding standard gray voltage value stored in the gamma register 27, and the LCD 26 displays under the regulated gray voltage value. After that, the gamma regulating system 20 repeats steps S21 to S23 until the measured digital voltage signal is in the range of allowable error band of the presetting standard luminance values, and stores the final regulating gray voltage in the gamma register 27. When the digital voltage signal representing current luminance is higher than a maximum value of the corresponding standard luminance, the MCU 24 decreases the gray voltage stored in the gamma register 27. In contrary, when the digital voltage signal representing current luminance is lower than a minimum value of the corresponding standard luminance, the MCU 24 increases the gray voltage stored in the gamma register 27.

In step S24, the MCU 24 screens the current final regulated gray voltage, and step S21 to step S23 are repeated for regulating next gray scale.

In step S25, after each gray scale is regulated, the MCU 24 tells the main controller 25 that the gamma regulating for the LCD 26 is finished, and the main controller 25 sends another controlling signal to turn off the MCU 24.

The gamma regulating system 20 and the gamma regulating method utilize the light sensor 21 to detect the actual display luminance of each gray scale for the LCD 26, and further utilize the MCU 24 to compare the actual display luminance and the standard luminance value of the standard gamma curve to regulate the corresponding gray voltage for realizing an automatic gamma regulating according the comparing result thereof. Because the gamma regulating is automatically finished by the gamma regulating system 20, no manpower is needed. Therefore, the manufacturing cost is decreased.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A gamma regulating system for an LCD, comprising:
a test-needed LCD displaying each gray scale image according to internal presetting standard gamma curve;
a light sensor measuring a luminance value of the gray scale image displayed by the test-needed LCD, and converting the luminance value to a voltage signal;
a MCU comparing the voltage signals representing the measured luminance values with the parameter data corresponding to the standard gamma curve, and regulating a gray voltage according the comparing result.

2. The gamma regulating system as claimed in claim 1, wherein the parameter data corresponding to the standard gamma comprises gray scale values and corresponding standard luminance values

3. The gamma regulating system as claimed in claim 2, wherein the gamma regulating system further comprises a gamma register for storing the parameter data corresponding to the standard gamma curve and corresponding gray voltages.

4. The gamma regulating system as claimed in claim 1, wherein the light sensor converts the luminance value to an analog voltage signal.

5. The gamma regulating system as claimed in claim 4, wherein the gamma regulating system further comprises an analog/digital (A/D) converter, which converts the analog voltage signal to a digital voltage signal representing the luminance value, and sends the digital voltage signal to the MCU.

6. The gamma regulating system as claimed in claim 4, wherein the gamma regulating system further comprises an amplify circuit for scaling up the analog voltage signal, and transmitting the amplified analog voltage signal to the A/D converter.

7. The gamma regulating system as claimed in claim 1, wherein the MCU regulates the gray voltage according the comparing result until the voltage signal representing the measured luminance value is in a range of allowable error for the presetting standard luminance values of the standard gamma curve.

8. The gamma regulating system as claimed in claim 1, wherein the gamma regulating system further comprises a main controller which controls the MCU to perform gamma regulating action, and turns off the MCU after the gamma regulating of the LCD is finished.

9. A gamma regulating method for an LCD, comprising:
providing a test-needed LCD and operating the LCD to display each gray scale image according to internal presetting standard gamma curve;
measuring an actual display luminance through a light sensor and converting the display luminance to a voltage signal;
comparing the voltage signals representing the actual luminance values with the parameter data corresponding to the standard gamma curve, and regulating a gray voltage according the comparing result by a micro control unit (MCU).

10. The gamma regulating method as claimed in claim 9, further comprising a step of sending a start signal to turn on the MCU through a main controller, and a step of creating a plurality of data signals respectively representing one gray scale image to the test-needed LCD.

11. The gamma regulating method as claimed in claim 10, further comprising a step of sending another controlling signal to turn off the MCU by the main controller after each gray scale are regulated.

12. The gamma regulating method as claimed in claim 9, wherein light sensor converts the actual luminance value to an analog voltage signal.

13. The gamma regulating method as claimed in claim 12, further comprising a step of scaling up the analog voltage signal by an amplify circuit.

14. The gamma regulating method as claimed in claim 9, further comprising a step of converting the analog voltage signal to a digital voltage signal through an A/D converter.

15. The gamma regulating method as claimed in claim 9, wherein the MCU regulates the gray voltage according a comparing result until the voltage signal representing the measured luminance value is in a range of allowable error for the presetting standard luminance values of the standard gamma curve.

16. The gamma regulating method as claimed in claim 15, further comprising the MCU screening the current final regulating gray voltage, and repeating regulating each gray scale.
